(19) United States
(12) Patent Application Publication
(10) Pub. No.: US 2002/0095580 A1
(43) Pub. Date: Jul. 18, 2002

(54) Secure transactions using cryptographic processes

(76) Inventor: Brant Candelore, Escondido, CA (US)

Correspondence Address: Sheryl Sue Holloway, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/993,781

(22) Filed: Nov. 13, 2001

Related U.S. Application Data
(60) Provisional application No. 60/254,327, filed on Dec. 8, 2000.
(60) Provisional application No. 60/254,511, filed on Dec. 8, 2000.

(51) Int. Cl. H04L 9/00

(52) U.S. Cl. 713/178

(57) ABSTRACT

Data is obtained from a device for use as an input to a first cryptographic process. An output of the first cryptographic process is created and the output is written to a storage location after the device is received by a user. The output is valid for a limited period of time.

### RELATED APPLICATIONS

This application hereby claims the benefit of the filing date of provisional applications entitled, Method for Securing Bankcard Transactions With Secure Time Hash, Serial No. 60/254,327 filed Dec. 8, 2000 and Method for Securing Bankcard Transactions With Secure Time Hash, Serial No. 60/254,511 filed Dec. 8, 2000. The provisional applications are hereby incorporated by reference into the present application.

### BACKGROUND OF THE INVENTION

1. Field of the Invention

The invention relates generally to securing transactions performed with a device or a personal transaction card, and more specifically to securing those transactions using cryptographic processes.

2. Art Background

Bankcards are used to perform a variety of business transactions that range from banking to purchases of goods and services via telephone. Typically point of sale (POS) terminals are read only devices. These POS terminals are set up to read a magnetic stripe on the back of a bankcard when the bankcard is presented for payment during a transaction. The magnetic stripe contains much of the same information as embossed on the front of the bankcard.

The embossed data is the raised plastic lettering that typically contains the following information; account number, “valid from” date; “good thru” date; and account holder name. In addition the magnetic stripe typically contains a cryptographic number often referred to as a “cryptogram.” The cryptogram is read along with the other data on the magnetic stripe. The cryptogram is typically used to determine “Card Present” status within the POS terminal. The bankcard may also have printed card information as well. Printed card information might include: “issuing bank;” loyalty affiliations (e.g. Frequent Flyer Plan); and loyalty affiliation account number.

The magnetic stripe information on the bankcards may be easily read and fraudulent bankcards may be cloned with this information. The magnetic stripe information does not change during the useful life of the bankcard. Bankcards are typically used to pay for meals in restaurants. It is easy for a sales clerk or waiter in a restaurant to make a copy of the bankcard information and then use it for a fraudulent purpose. Bankcard information may also be picked out of the trash and misappropriated for a fraudulent use. For example, a fraudulently placed telephone order may occur due to the lack of security during the telephone transaction.

One prior art attempt at solving this problem is the introduction of microprocessor-based smart cards. The introduction of microprocessor based smart cards has not gained much acceptance because of the existing magnetic stripe infrastructure. The magnetic stripe reader within a typical POS terminal cannot write data to the magnetic stripe. This deficiency, in the presently deployed POS terminals, makes it difficult to implement a challenge and response protocol, which would raise the level of bankcard security.

What is needed is a security system that prevents the fraudulent use of bankcard information that is compatible with the existing infrastructure of POS terminals.

### SUMMARY OF THE INVENTION

Data is obtained from a device for use as an input to a first cryptographic process. An output of the first cryptographic process is created and the output is written to a storage location after the device is received by a user. The output is valid for a limited period of time.

### BRIEF DESCRIPTION OF THE DRAWINGS

The objects, features, and advantages of the invention will be apparent from the following detailed description in which like references indicate similar elements.

FIG. 1A illustrates a numeric representation of the output of a cryptographic process, being displayed on a device display following authorization for use.

FIG. 1B illustrates an interaction between a device, a personal transaction card, and an output of a cryptographic process.

FIG. 2 illustrates several embodiments of a method for performing a cryptographic process.

FIG. 3 illustrates a block diagram of several embodiments of a cryptographic processor that could be used to perform a cryptographic process.

FIG. 4A illustrates existing data fields on a magnetic stripe of a device and a location for an output of a cryptographic process within the data fields.

FIG. 4B illustrates existing data fields on a magnetic stripe of a personal transaction card.

FIG. 5 is a simplified block diagram of one embodiment of a privacy card for a personal transaction device.

FIG. 6 is a simplified block diagram of one embodiment of a digital wallet for a personal transaction device.

FIG. 7 is a simplified block diagram of a consumer purchasing system using a point of sale (POS) terminal.

FIG. 8 illustrates one embodiment of a method for using cryptographic processes in a secure consumer purchasing methodology.

FIG. 9 is a simplified block diagram of consumer purchasing system using a point of sale (POS) terminal and a Transaction Privacy Clearing House (TPCH).

FIG. 10 is a simplified block diagram of one embodiment of a secure transaction system.

### DETAILED DESCRIPTION

In the following detailed description of embodiments of the invention, reference is made to the accompanying drawings in which like references indicate similar elements, and in which is shown by way of illustration, specific embodiments in which the invention may be practiced. These embodiments are described in sufficient detail to enable those skilled in the art to practice the invention. The following detailed description is, therefore, not to be taken in a limiting sense, and the scope of the invention is defined only by the appended claims.

In one embodiment, a device may be used with cryptographic processes to create a security system that prevents fraudulent use of the device. The security system is initiated after the device transfers, or writes an output of a cryptographic process to a storage location after the device is received by a user.

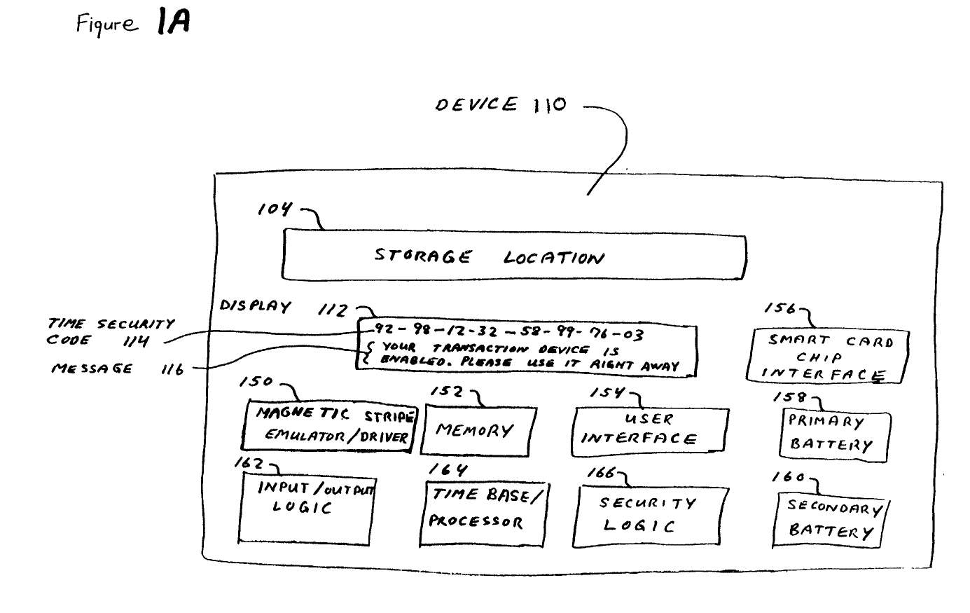

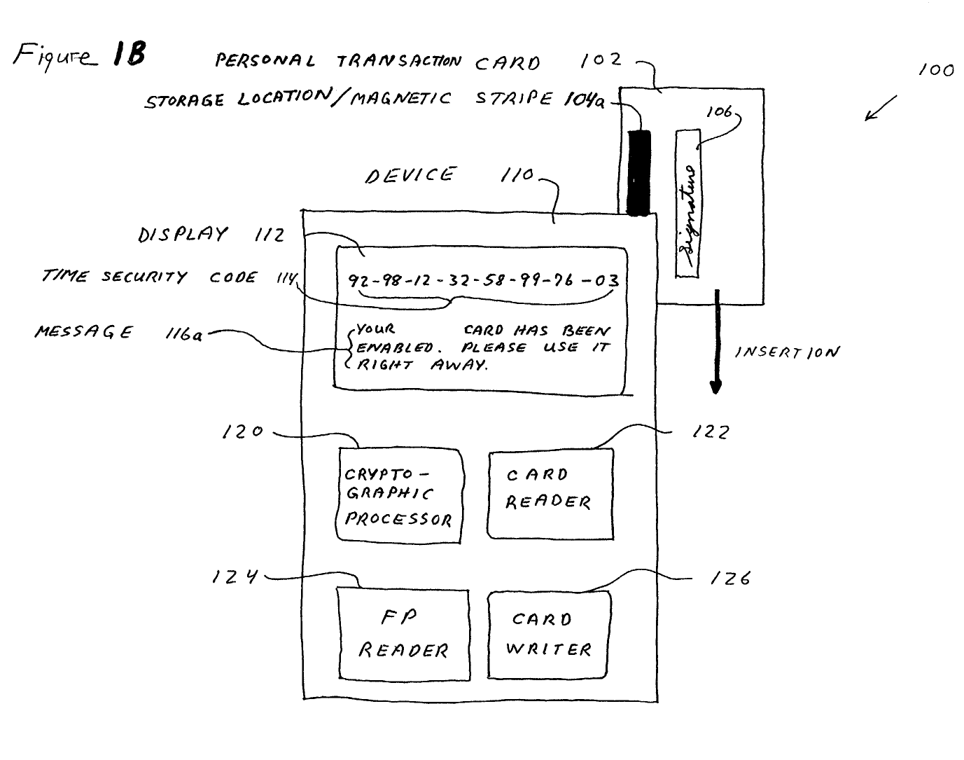

In one embodiment, the device may be configured as shown in FIG. 1A. With reference to FIG. 1A, a numeric representation of the output of the cryptographic process, shown as a time security code 114 on a display 112, is written or transferred to a storage location 104 of device 110. Transferring the output of the cryptographic process to the storage location 104 effects an authorization for use of the device, which is indicated by message 116 on the display 112. The storage location 104 may be a magnetic stripe emulator. Alternatively, the storage location 104 may be a bar code emulator. In another embodiment, described below in conjunction with FIG. 1B, the storage location is on a personal transaction card. As used herein, the personal transaction card may be any card with a magnetic stripe.

Various cryptographic processes may be employed that will result in a variety of different outputs. The output of the cryptographic process may be referred to by a variety of terms that are well known in the art such as an encryption, or a cryptogram. The invention is not limited by the type of cryptographic process performed or the form of the output of the cryptographic process. For instance, in one embodiment, the cryptographic process produces a hash from information obtained from the device. In another embodiment the cryptographic process produces an encrypted hash with the use of a key. Encryption may be performed symmetrically where a key used for decryption is the same as the key used for encryption and vice versa. Alternatively, the encryption may be asymmetric, where the key used for encryption is different from the key used for decryption. Asymmetric encryption is also characterized by the fact that a decryption key cannot be calculated (at least in a reasonable amount of time) from an encryption key.

In addition to the information obtained from the device, the cryptographic process may use a number of additional pieces of information. A non-exhaustive list of some examples of such additional pieces of information includes: time; user input information such as a personal identification number (PIN); biometric data such as a fingerprint; a DNA sample; acoustic data from a user; such as a voice sample or data from the device such as a globally unique silicon ID (GUID). Analysis of the user's DNA may be performed with a “laboratory on a chip” solution that automatically analyzes a DNA sample and reports the results electronically. One example of the “laboratory on a chip” for DNA analysis has been developed at the University of Michigan and reported by the University of Michigan News and Information Services on Oct. 21, 1998.

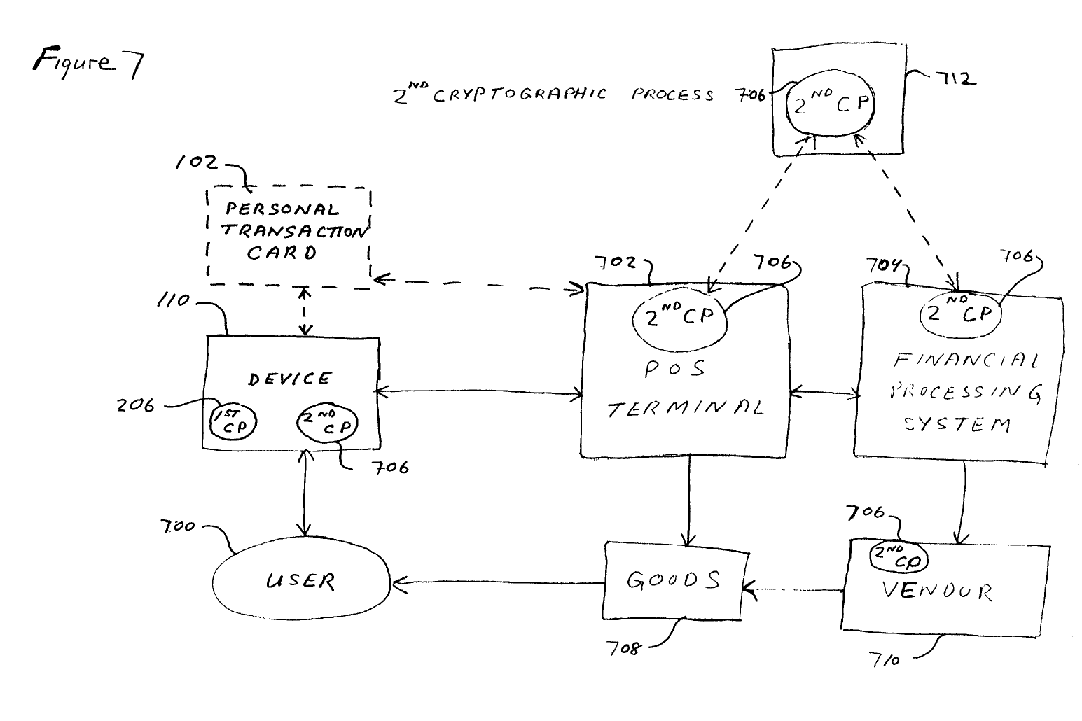

In one embodiment, a security logic 166, a user interface 154, and a memory 152 perform the cryptographic process. User information may be input to the device through the user interface 154. Many types of user interfaces are contemplated, such as a fingerprint (FP) reader. Alternatively, numeric or alpha data may be input by the user through various interfaces that are well known in the art, such as a touch panel on device 110. In addition to, or alternatively, keypads may be provided as well as interfaces for inputting other biometric data such as DNA or acoustic data. The user information may be combined with the device data during the cryptographic process. User information may be used as a key during the cryptographic process or subsequent to the cryptographic process during the authorization of the device for use in conducting a transaction. In one embodiment, time information from a time base/processor 164 may be used during the cryptographic process or subsequent to the cryptographic process. The device may contain input/output logic 162 that may be used in conjunction with smart card chip interface 156 and or magnetic stripe emulator/driver 150 to communicate as needed in order to perform the required transactions, which will be described below in conjunction with FIG. 6 and FIG. 7.

In one embodiment, the device is used to perform the cryptographic process and to transfer the output of the cryptographic process to the personal transaction card. FIG. 1B illustrates the interaction between the device and the personal transaction card at 100. With reference to FIG. 1B, a numeric representation of the output of the cryptographic process, shown as time security code 114, on the display 112, is written to a storage location/magnetic stripe 104a of the personal transaction card 102 by the device 110. Transferring the output of the cryptographic process to the personal transaction card 102 effects an authorization for use of the personal transaction card, which is indicated by message 116a on the device display 112.

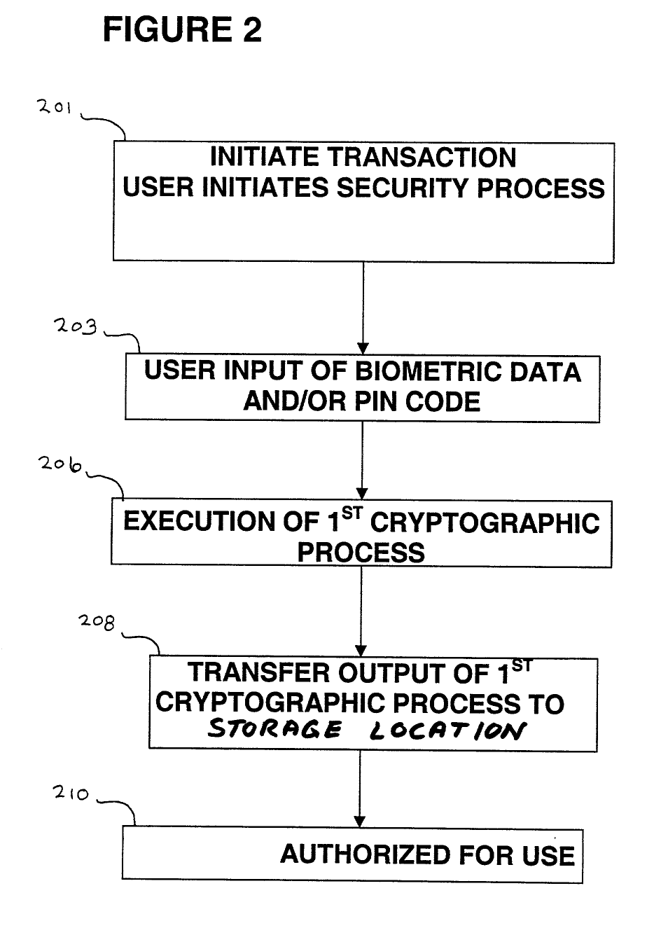

FIG. 2 illustrates several embodiments of a method for performing the cryptographic process. With reference to FIG. 2, at block 201 a user may initiate the transaction by initiating a security process to activate the device via a user interface. Block 201 may also include selecting a particular account from a plurality of accounts administered by the given device. The device may retrieve account data from storage. A device may be configured to work with a number of accounts. Identification of one of these accounts on the device may cause the device to look up the pertinent account data from local memory or retrieve the data from a network. If additional user supplied data is required by the cryptographic process the user supplies that data at block 203 via an appropriate user interface, supplying a PIN code, a fingerprint, the DNA sample, an acoustic signature, etc. The calculation of the first cryptographic process generates an output at block 206. The output of the first cryptographic process is transferred to the storage location at block 208. Account data may also be transferred to the storage location when a device is configured to work with a plurality of accounts. The device is now authorized for use as indicated at block 210. Additional information, such as the time of occurrence, associated with any of the process blocks shown in FIG. 2 may also be used in the first cryptographic process. The significance of using time in this manner is that the duration of device authorization may be limited to a finite period of time. Limiting the period of authorization for use protects against use of the device if it is lost or stolen in an authorized condition.

Alternatively, the method for performing the cryptographic process can transfer the output of the cryptographic process to the personal transaction card. With reference to FIG. 2, a transaction is initiated at block 201, when, for example, the personal transaction card is placed in a slot of the device 110 (FIG. 1B), which may be part of the card reader 122 (FIG. 1B).

Alternatively, wireless communication occurring between the personal transaction card and the device, as discussed above, could initiate a transaction at block 201. The device can read data from the personal transaction card. Alternatively, the device could retrieve personal transaction card data from a storage device. The device may be configured to work with a number of personal transaction cards. Insertion of one of these personal transaction cards into the device may cause the device to look up the pertinent personal transaction card data from local memory or retrieve the data from a network. If additional user supplied data is required by the cryptographic process the user supplies that data at block 203 via an appropriate user interface configured to allow input of the PIN, the fingerprint, the DNA sample, the acoustic signature, etc. Execution of the first cryptographic process at block 206 generates an output at block 208. The output of the first cryptographic process is stored on the personal transaction card at block 208. The personal transaction card is now authorized for use as indicated at block 210.

Additional information, such as the time stamp associated with any of the process blocks shown in FIG. 2 may also be used in the first cryptographic process. The significance of using the time stamp in this manner is that the duration of device or personal transaction card authorization may be limited to a finite period of time. Limiting the period of authorization for use of the device or personal transaction card protects against use of the account if the device or personal transaction card is lost or stolen in an authorized condition.

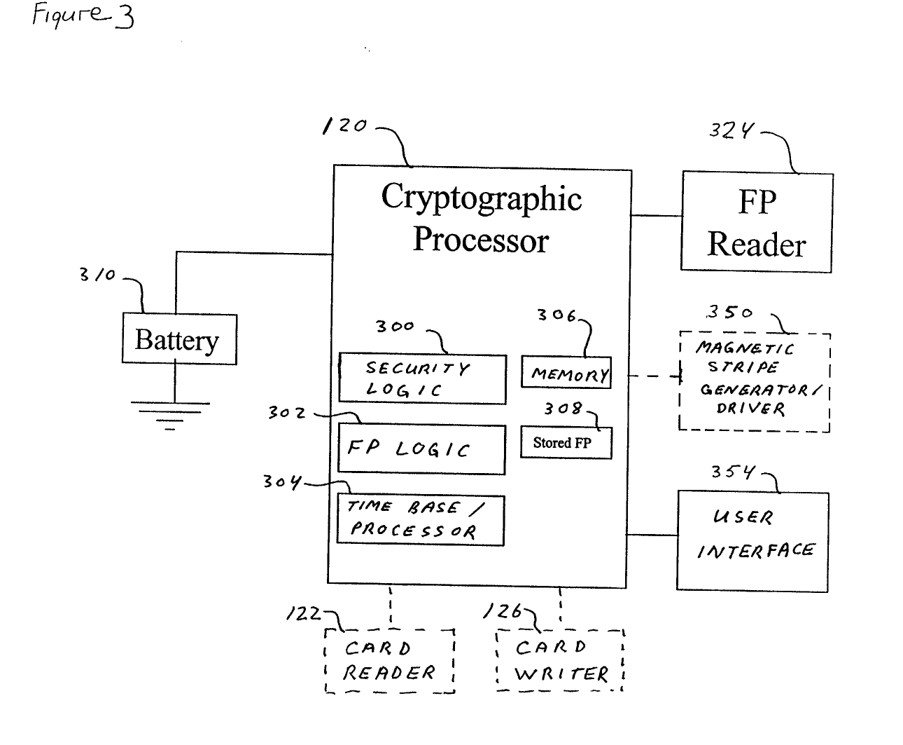

FIG. 3 illustrates a block diagram of several embodiments of a cryptographic processor that is used to perform the cryptographic process. With reference to FIG. 3, in one embodiment, the cryptographic processor 120 is connected with a FP reader 324, a magnetic stripe generator/driver 350, a user interface 354, and a battery 310. In one embodiment, the cryptographic processor 120 includes a biometric solution for security, including a FP logic 302 and a stored FP 308. The user would initiate the security processes at block 201 and at block 203 (FIG. 2) by pressing a finger on the FP reader 324. If the user was the user whose fingerprint had previously been stored in the stored FP 308, authorization would be granted and the cryptographic process would proceed. The FP logic 302 would perform the required comparison of the stored fingerprint with the user input fingerprint. The user may enter user information that may be used with, or in place of, the fingerprint via the user interface 354. User information may be used by a security logic 300. The cryptographic process may proceed with the aid of the security logic 300, a memory 306, and a time/base processor 304. As previously discussed the output of the cryptographic process may be the hash, the encrypted hash, the encryption, the cryptogram, etc. with the appropriate key or lack of key according to the level of security desired for the given implementation of the security system. The output of the cryptographic process may be communicated to the magnetic stripe of the device with magnetic stripe generator/driver 150 (FIG. 1A). Alternatively, as shown in FIG. 1B, the cryptographic processor 120 is coupled with a card reader 122 and a card writer 126 to facilitate transfer of data from the personal transaction card 102 to the device 11 0.

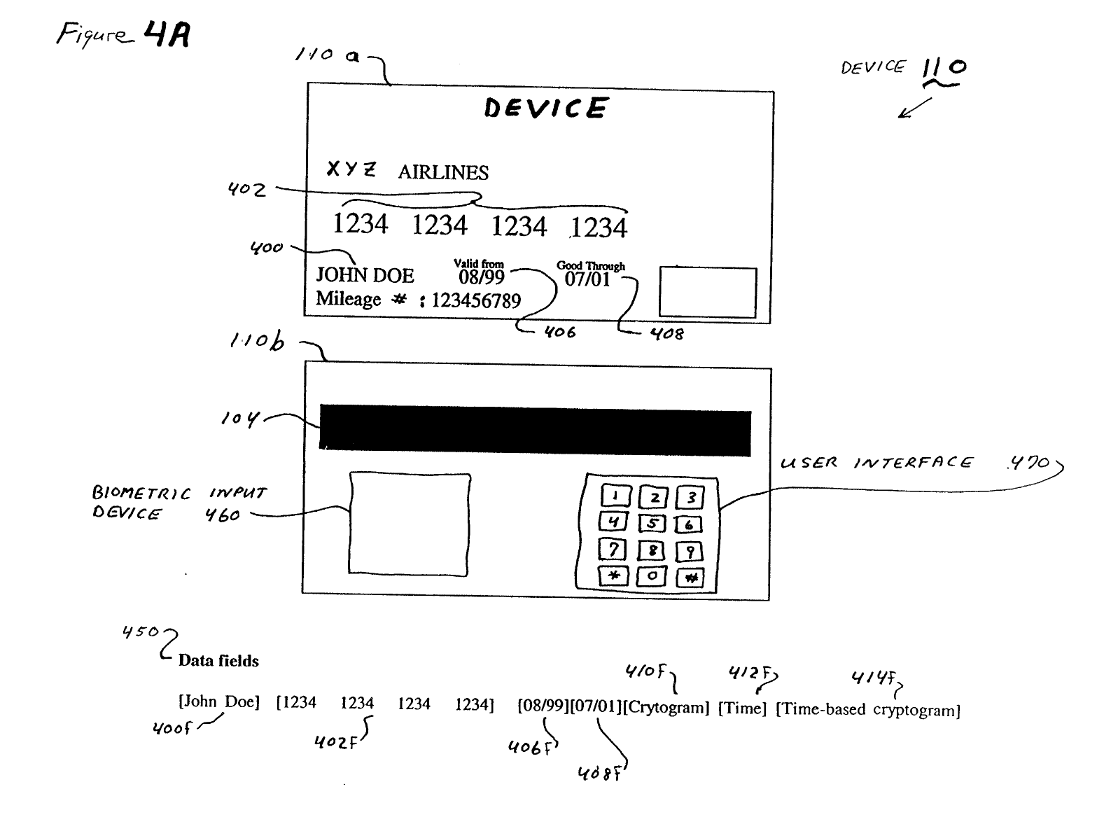

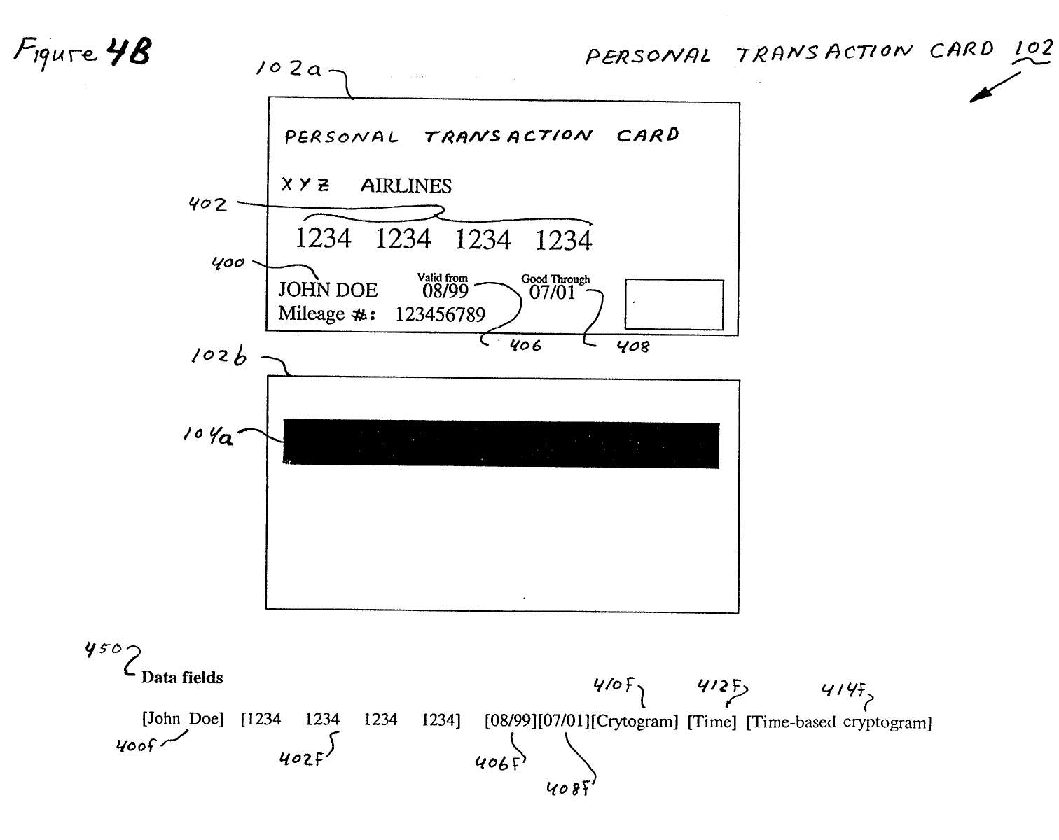

In one embodiment, the device 110 may be configured to be compatible with the data format of existing bankcards. The device 110 may be configured similarly to a bankcard and may be read by point of sale (POS) terminals. With reference to FIG. 4A, an embossed side 110a of the device 110 is shown with data that may be used in the cryptographic process. An account number 402, a user's name 400, a “valid from” date 406, a “good through” date 408 are presently stored in data fields of the storage location 104.

The storage location 104 is shown on an opposing side 110b of the device 110, containing data fields 450. The data fields presently used in the storage location 104 include user name 400f (which correspond to user's name 400), account number 402f, a “valid from” date 406f, a “good through” date 408f, a cryptogram 41 Of used to determine card present status, and two unused data fields 412f and 414f. In one embodiment, the data field 412f may be used to store a time stamp, and 414f may be used to store the output of the cryptographic process. The time stamp, stored in field 412f, may be related to the period of authorization for use of the device 110. In an alternative embodiment, time would not be stored in field 412f; only the output of the cryptographic process would be stored in 414f. In one embodiment, the output of the cryptographic process is a time-based cryptogram that is stored in data field 414f. The user may supply user information via a biometric input device 460 or a user interface 470 as shown on 110b.

In an alternative embodiment, FIG. 4B illustrates the personal transaction card 102 having a magnetic stripe with an unused data field, which may be used as the storage location to store the output of the cryptographic process. With reference to FIG. 4B, an embossed side of a personal transaction card 102a is shown with personal transaction card data that may be used in the cryptographic process. A personal transaction card account number 402, a personal transaction card user's name 400, a “valid from” date 406, and a “good through” date 408 are typically written on data fields on the storage location/magnetic stripe 104a. The storage location/magnetic stripe 104a is shown on an opposing side 102b of the personal transaction card, containing data fields 450. Data fields presently used on the storage location/magnetic stripe 104a include a user name 400f (which corresponds to personal transaction card user's name 400), an account number 402f, a “valid from” date 406f, a “good through” date 408f, a cryptogram 41 Of, and two unused data fields 412f and 414f. The cryptogram 41 Of is used to determine card present status. In one embodiment, the data field 412f may be used to store a time stamp, and 414f may be used to store the output of the cryptographic process. The time stamp, stored in field 412f, may be related to a period of authorization for use of the personal transaction card. In an alternative embodiment, time would not be stored in field 412f; only the output of the cryptographic process would be stored in 414f. In yet another embodiment, the output of the cryptographic process is a time-based cryptogram that is stored in the data field 414f.

The device 110 and the personal transaction card 102 may be employed in various embodiments according to the teaching herein. For example, the device 110 may be a personal transaction device (PTD) or a privacy card or a digital wallet. In one embodiment, the user connects to and performs transactions with a secure transaction system (such as shown in FIG. 10) through the personal transaction device (PTD) that has a unique identifier (ID). In one embodiment, the privacy card is used. In an alternate embodiment a digital wallet is used. In yet another alternate embodiment, the privacy card in conjunction with the digital wallet is used.

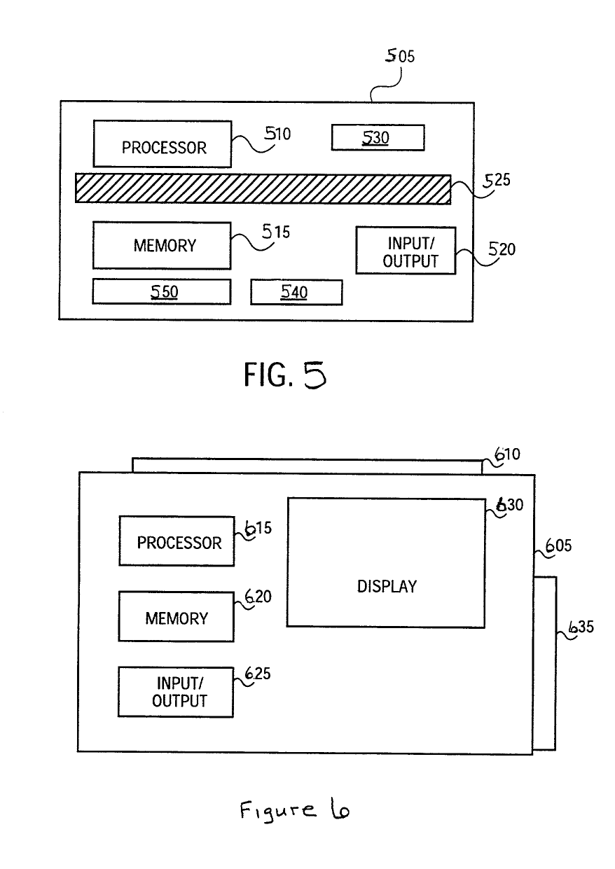

One embodiment of a privacy card 505 is illustrated in FIG. 5. In one embodiment, the card 505 is configured to be the size of a credit card. The privacy card includes a processor 510, memory 515 and input/output logic 520. The processor 510 is configured to execute instructions to perform the functionality herein. The instructions may be stored in the memory 515. The memory is also configured to store data, such as transaction data and the like. In one embodiment, the memory 515 stores the transaction ID used to perform transactions in accordance with the teachings of the present invention. Alternately, the processor may be replaced with specially configured logic to perform the functions described here.

The input/output logic 520 is configured to enable the privacy card 505 to send and receive information. In one embodiment, the input/output logic 520 is configured to communicate through a wired or contact connection. In another embodiment, the input/output logic 520 is configured to communicate through a wireless or contactless connection. A variety of communication technologies may be used.

In one embodiment, a display 525 is used to generate bar codes scanable by coupled devices and used to perform processes as described herein. The privacy card 505 may also include a magnetic stripe generator 540 to simulate a magnetic stripe readable by devices such as legacy (existing) POS terminals.

In one embodiment, biometric information, such as fingerprint recognition, is used as a security mechanism that limits access to the card 505 to authorized users. A fingerprint touch pad and associated logic 530 is therefore included in one embodiment to perform these functions. Alternately, security may be achieved using a smart card chip interface 550, which uses known smart card technology to perform the function.

Memory 515 can have transaction history storage area. The transaction history storage area stores transaction records (electronic receipts) that are received from POS terminals. The ways for the data to be input to the card include wireless communications and the smart card chip interface which functions similarly to existing smart card interfaces. Both of these approaches presume that the POS terminal is equipped with the corresponding interface and can therefore transmit the data to the card.

Memory 515 can also have user identity/account information block. The user identity/account information block stores data about the user and accounts that are accessed by the card. The type of data stored includes the meta account information used to identify the account to be used.

One embodiment of a digital wallet 605 is illustrated in FIG. 6. The digital wallet 605 includes a coupling input 610 for the privacy card 505, processor 615, memory 620, input/output logic 625, display 630 and peripheral port 635. The processor 615 is configured to execute instructions, such as those stored in memory 620, to perform the functionality described herein. Memory 620 may also store data including financial information, eCoupons, shopping lists and the like. The digital wallet may be configured to have additional storage. In one embodiment, the additional storage is in a form of a card that couples to the device through peripheral port 610.

In one embodiment, the privacy card 505 couples to the digital wallet 605 through port 610; however, the privacy card 505 may also couple to the digital wallet 605 through another form of connection including a wireless connection.

Input/output logic 625 provides the mechanism for the digital wallet 605 to communicate information. In one embodiment, the input/output logic 625 provides data to a point of sale terminal or to the privacy card 505 in a prespecified format. The data may be output through a wired or wireless connection.

The digital wallet 605 may also include a display 630 for display of status information to the user. The display 630 may also provide requests for input and may be a touch sensitive display, enabling the user to provide the input through the display.

The physical manifestation of many of the technologies in the digital wallet 605 will likely be different from those in the privacy card 505, mainly because of the availability of physical real estate in which to package technology. Examples of different physical representations would include the display, fingerprint recognition unit, etc.

The security process proceeds with data from the storage location associated with the device or personal transaction card being read with the POS terminal, as shown in FIG. 7. POS terminal 702 may be any one of a number of such apparatuses configured to read data from the storage location associated with the device 110 or the personal transaction card 102. A non-exclusive list of compatible terminals includes a legacy POS terminal, a home computer system, a bank automatic teller machine (ATM) terminal, a digital television, an Internet appliance, and a personal POS terminal. FIG. 7 is a simplified block diagram of a consumer purchasing system using POS terminal 702. With reference to FIG. 7, the user 700 causes the first cryptographic process 206 to occur on the device 110, as previously described. During a transaction, the POS terminal 702 reads data from the storage location on the device 110 or personal transaction card 102. The POS terminal 702 may be configured according to the typical installation in commercial establishments, wherein POS terminal 702 communicates with a financial processing system 704 to verify the desired transaction.

In a prior art transaction with a bankcard, the transaction would be permitted based on account information, such as availability of credit, on whether the current date of the sale is within the “valid from” and “good through” dates. In this prior art transaction there is no method of preventing fraudulent use of the bankcard, other than a sales person comparing a signature written on the bankcard with the user's signature at the time of purchase. A telephone order performed with bankcard information does not allow the real time comparison of signatures by the sales person and is susceptible to fraudulent use of the bankcard.

In one embodiment, a second cryptographic process 706 is performed when the user 700 commences the transaction with the device 110 and the POS terminal 702. The second cryptographic process 706 may take place in a variety of locations, such as at the POS terminal 702, the financial processing system 704, a device 712, a vendor 710 or in the device 110.

In an alternative embodiment, the second cryptographic process 706 is performed when the user 700 commences the transaction with the personal transaction card 102 and the POS terminal 702. The second cryptographic process 706 may take place in a variety of locations, such as at the POS terminal 702, the financial processing system 704, the vendor 710 or in the device 712.

The second cryptographic process may be performed exclusively within a given device or it may be performed with the cooperation of one or more of the entities shown in FIG. 7. Vendor 710 may perform the second cryptographic process in whole or in part. The second cryptographic process is used together with the first cryptographic process to authorize the consummation of the transaction or to prohibit the transaction. In one embodiment, the consummation of the transaction results in the movement of goods 708 to the user 700.

The second cryptographic process may assume a variety of forms and is related to the first cryptographic process according to the design of the security system implemented. For example, in one embodiment, a hash of certain account data output from the first cryptographic process would be compared to a subsequently created hash of the account data output from the second cryptographic process. Successful correlation of the two hashes would result in consummation of the transaction, while an unsuccessful correlation of the two hashes would result in the transaction being denied. Use of the first and second cryptographic processes, as previously described, circumvents the difficulty with accomplishing a challenge and response protocol using the device and the POS terminals that do not have write capability.

Many different first and second cryptographic processes are contemplated. For example, an encryption of the account and/or other data could be performed in the first cryptographic process 206. The second cryptographic process could perform a decryption using a key. The key used for decryption could be based on user input data or other data such as the GUID of the device 110. The decryption could return the original account and/or other data that was encrypted. A successful decryption of the appropriate data could be used to consummate the transaction. Alternatively, an unsuccessful decryption would result in the transaction being denied.

The time stamp may be used, as previously described in conjunction with FIG. 2 and FIG. 4, to limit the period of authorization for use of the device or personal transaction card. Using the time stamp in this way affords protection against use of the account if the device or personal transaction card is lost or stolen in an authorized condition. One embodiment incorporating the use of “time” may include encrypting time during the first cryptographic process. The second cryptographic process could decrypt the time at which the device 110 was authorized for use during the first cryptographic process. If the elapsed time between the first cryptographic process and the second cryptographic process was within a predetermined range the transaction could be authorized. Conversely, if the elapsed time was not within a predetermined range then the transaction would be denied.

Many different predetermined ranges are contemplated. For example, in one embodiment, a ten (10) minute interval may be employed wherein the device or personal transaction card was authorized for use during that ten-minute interval. If the attempted transaction was not completed within the ten-minute interval then the first cryptographic process would need to be repeated such that the device verified the identity of the user again before the device or personal transaction card was reauthorized for use during a subsequent ten-minute interval. In this manner, fraudulent use of the account is limited to the ten-minute interval if the user should lose possession of the authorized device or personal transaction card.

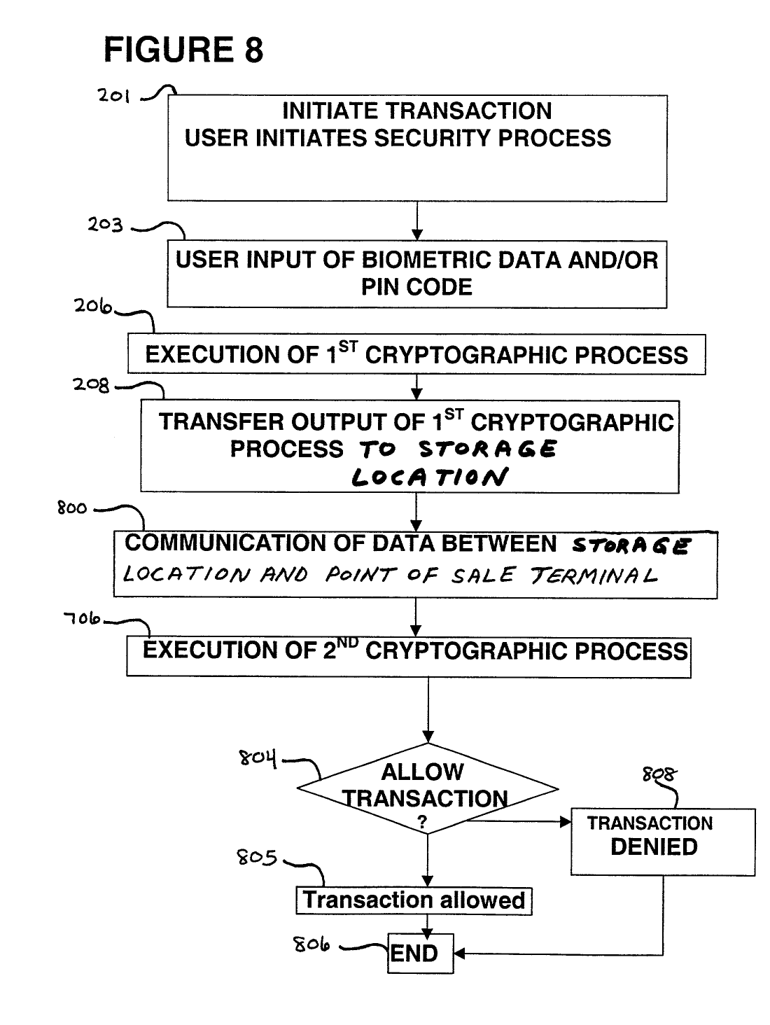

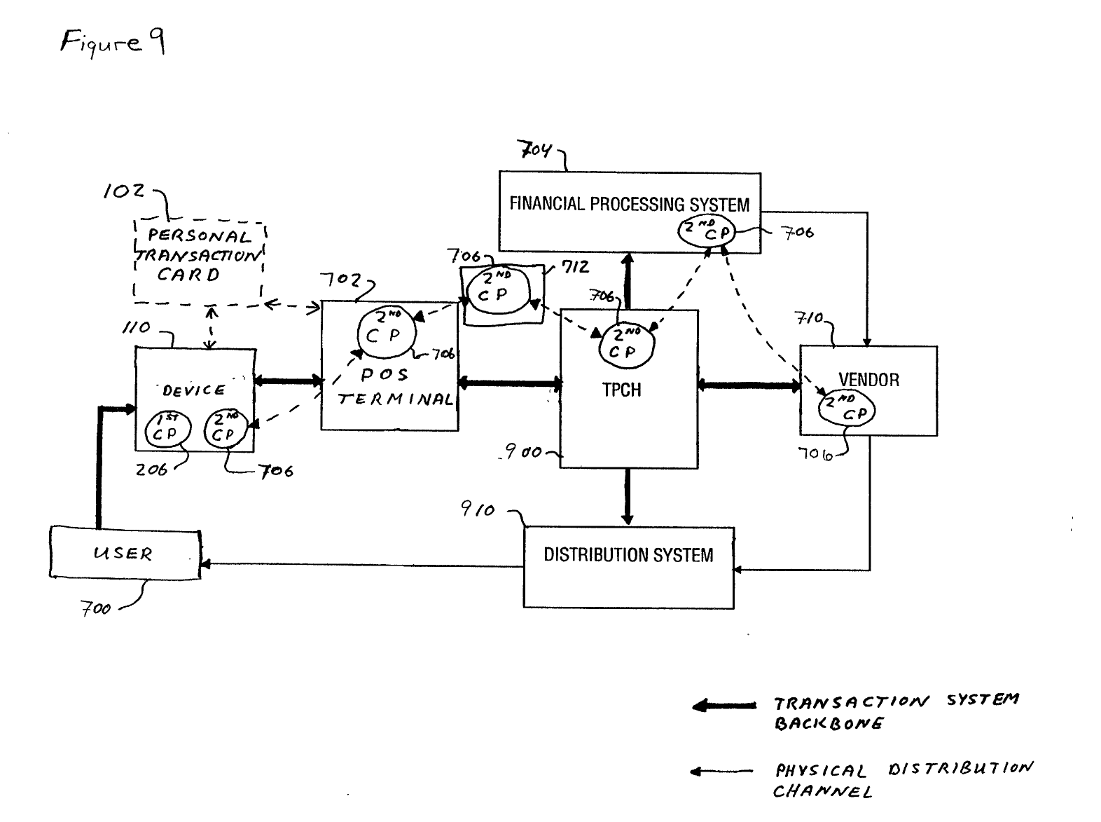

A method for conducting transactions, according to the foregoing description, is depicted in FIG. 8. FIG. 8 illustrates one embodiment of a process for using cryptographic processes in a secure consumer purchasing methodology. The processes represented by blocks 201, 203, 206, and 208 in FIG. 8, occur as discussed with respect to FIG. 2, resulting in the output of the first cryptographic process being written to the storage location 104 (FIG. 1A) of the device or the storage location/magnetic stripe 104a of the personal transaction card (FIG. 1B). Engaging the device or personal transaction card with the POS terminal results in the process at block 800, which causes a communication of data to occur between the device and the POS terminal. The second cryptographic process occurs at block 706. The transaction is either allowed to proceed to consummation at block 805 or it is denied at block 808 by evaluating the output and/or input of the first and second cryptographic processes at block 804. The method ends at block 806.

For example, an input to the first cryptographic process could be a user account number associated with the device or personal transaction card. The device could be configured to produce the encrypted hash as the output to the first cryptographic process. The POS terminal could perform a decryption during the second cryptographic process that would produce as the output, the user account number. In this example, the output of the second cryptographic process (user account number) is compared against the input to the first cryptographic process (user account number) by the POS terminal to allow or deny the transaction.

Alternatively, the second cryptographic process could be performed by device 110. An example, according to this embodiment, would entail repeating the processes represented by blocks 201, 203, 206 (where block 706 would perform a calculation of the second cryptographic process), and 208 after 800. The output of the second cryptographic process would be read by the POS terminal during a second application of the process at block 800 and be compared to the output and/or input of the first cryptographic process. The transaction would either proceed to consummation at block 805 or be denied at block 808 based on the outcome of the comparison. The method ends at block 806.

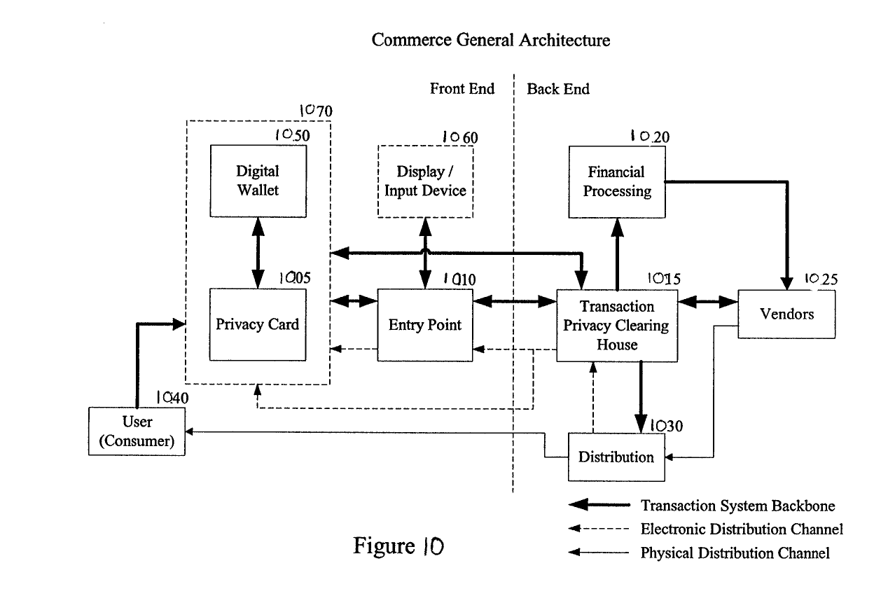

The foregoing methods and apparatuses for providing enhanced security during transactions may be used in a system employing a Transaction Privacy Clearing House (TPCH) as described below in conjunction with FIG. 10. FIG. 9 is a simplified block diagram of a consumer purchasing system using the point of sale (POS) terminal and the TPCH. As described previously, the user 700 causes the device 110 to execute the first cryptographic process 206. During the transaction, the POS terminal 702 reads data from the storage location associated with the device 110 or the personal transaction card 102. The POS terminal 702 is configured to communicate with the TPCH 900 to verify the desired transaction. Legacy POS terminals may be readily configured to interact with the TPCH 900. Alternatively 702 may be a personal point of sale terminal residing in the user's home or a mobile unit accompanying the user outside of the home. Utilizing this environment the user may perform transactions in or out of the home through the TPCH 900. The TPCH 900 interfaces with the financial processing system 704, the vendor 710, and a distribution system 910 to authorize and perform transactions.

In one embodiment, the second cryptographic process 706 is performed when the user 700 commences the transaction with the device 110 and the POS terminal 702. The second cryptographic process 706 may take place in a variety of locations, such as at the POS terminal 702, the TPCH 900, the financial processing system 704, the device 712, the vendor 710 or the device 110. The second cryptographic process may be performed exclusively within a given device or it may be performed with the cooperation of one or more of the entities shown in FIG. 9. Also, the vendor 710 may perform the second cryptographic process in whole or in part. The second cryptographic process is used together with the first cryptographic process to either authorize the consummation of the transaction or to prohibit the transaction. In one embodiment, the consummation of the transaction results in the movement of goods from distribution system 910 to the user 700.

Alternatively, the second cryptographic process could be performed by device 110 as previously discussed with respect to FIG. 8. Many different first and second cryptographic processes are contemplated within the system of FIG. 9.

FIG. 10 is a block diagram of one embodiment of a secure transaction system, which may be used in electronic commerce. In this embodiment, a transaction privacy clearing house (TPCH) 1015 interfaces a user (consumer) 1040 and a vendor 1025. In this particular embodiment, a personal transaction device (PTD) 1070, e.g., a privacy card 1005, or a privacy card 1005 coupled to a digital wallet 1050, is used to maintain the privacy of the user while enabling the user to perform transactions. In an alternate embodiment, the PTD 1070 may be any suitable device that allows unrestricted access to TPCH 1015. The personal transaction device information is provided to the TPCH 1015 that then indicates to the vendor 1025 and the user 1040 approval of the transaction to be performed.

In order to maintain confidentiality of the identity of the user 1040, the transaction device information does not provide user identification information. Thus, the vendor 1025 or other entities do not have user information but rather transaction device information. The TPCH 1015 maintains a secure database of transaction device information and user information. In one embodiment, the TPCH 1015 interfaces to at least one financial processing system 1020 to perform associated financial transactions, such as confirming sufficient funds to perform the transaction, and transfers to the vendor 1025 the fees required to complete the transaction. In addition, the TPCH 1015 may also provide information through a distribution system 1030 that, in one embodiment, can provide a purchased product to the user 1040, again without the vendor 1025 knowing the identification of the user 1040. In an alternate embodiment, the financial processing system 1020 need not be a separate entity but may be incorporated with other functionality. For example, in one embodiment, the financial processing system 1020 may be combined with the TPCH 1015 functionality.

In one embodiment, the financial processing system (FP) 1020 performs tasks of transferring funds between the user's account and the vendor's account for each transaction. In one embodiment, the presence of the TPCH 1015 means that no details of the transactions, other than the amount of the transactions and other basic information, are known to the FP 1020. The TPCH 1015 issues transaction authorizations to the FP 1020 function on an anonymous basis on behalf of the user over a highly secure channel. The FP 1020 does not need to have many electronic channels receiving requests for fund transfer, as in a traditional financial processing system. In another embodiment, a highly secure channel is set up between the TPCH 1015 and the FP 1020; thus, the FP 1020 is less vulnerable to spoofing.

In one embodiment, the FP 1020 is contacted by the TPCH 1015 requesting a generic credit approval of a particular account. Thus the FP 1020 receives a minimal amount of information. In one embodiment, the transaction information, including the identification of goods being purchased with the credit need not be passed to the FP 1020. The TPCH 1015 can request the credit using a dummy charge ID that can be listed in the monthly credit statement sent to the user, so that the user can reconcile his credit statement. Further, the personal transaction device 1005 can include functionality to cause the credit statement to convert the dummy charge ID back to the transactional information so that the credit statement appears to be a conventional statement that lists the goods that were purchased and the associated amount charged.

A display input device 1060 (shown in phantom) may be included to enable the user, or in some embodiments the vendor 1025, to display status and provide input regarding the PTD 1005 and the status of the transaction to be performed.

In yet another embodiment, an entry point 1010 interfaces with the personal transaction device 1070 and also communicates with the TPCH 1015. The entry point 1010 may be an existing (referred to herein as a legacy POS terminal) or a newly configured point of sale (POS) terminal located in a retail environment. The user 1040 uses the PTD 1070 to interface to the POS terminal in a manner similar to how credit cards and debit cards interface with POS terminals. The entry point 1010 may also be a public kiosk, a personal computer, or the like.

The system described herein also provides a distribution functionality 1030 whereby products purchased via the system are distributed. In one embodiment, the distribution function 1030 is integrated with the TPCH 1015 functionality. In an alternate embodiment, the distribution function 1030 may be handled by a third party. Utilizing either approach, the system ensures user privacy and data security. The distribution function 1030 interacts with the user through PTD 1030 to ship the product to the appropriate location. A variety of distribution systems are contemplated; for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, it involves the use of a “package distribution kiosk” that allows the user to retrieve the package from the kiosk in a secure fashion. However, in one embodiment, the user may use PTD 1070 to change the shipping address of the product at any time during the distribution cycle.

It is anticipated, that in one or more embodiments, the invention will be practiced by allowing multiple users to use the device. Some examples of multiple users are a husband and a wife using the device or a parent and a child using the device. Alternatively, multiple users may include employees of a business organization or members of a group. The number or identity of the users is flexible and may be arranged without constraint.

Different levels of authorization for use may be provided to the multiple users by one or more users who are in charge of the device. Levels of authorization for use may include precluding certain types of transactions, restricting certain users to certain types of transactions, and placing limits on transactions. In one embodiment, the levels of authorization for use are some of the additional pieces of information that are used as input to the cryptographic process as discussed previously with respect to FIGS. 1-4. The additional pieces of information may be used during the second cryptographic process as described in conjunction with FIG. 7. For example, parents may wish to limit the types of transactions that their children are allowed to make with the device. Limitations may be placed on the type of transaction or the pecuniary value of the transaction.

For example, the device may be configured by the parent for the child's use, where the child's authorization is limited to purchases of up to a certain pecuniary value. The child's authorization may also be limited to transactions of a certain type such as purchases of food but not purchases of toys or obtaining a cash advance. The child who attempts to make a cash advance transaction, where that level of authorization has not been provided, at block 804 (FIG. 8), would be denied at block 808 (FIG. 8).

Configuring the device, for multiple levels of use, may be performed initially by the user or users who are in charge of defining the levels of authorization for use of the device. Reconfiguring the device for different level(s) of authorization for the particular user(s) may occur subsequent to the initial configuration.

It is also anticipated that the invention may be practiced by associating more than one device with one or more financial accounts, thereby enabling simultaneous use of the devices by multiple users. In this embodiment, simultaneous users of the devices are provided with the same security as the single user of the single device previously described.

The components of a secure transaction system illustrated in FIGS. 5, 6, and 10 are further described in PCT published patent application number US00/35619, which is assigned to the same assignee as the present application and which is hereby incorporated by reference.

It will be appreciated that the methods described in conjunction with the Figures and may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

Thus, a novel security system, based on the cryptographic processes is described. Although the invention is described herein with reference to specific preferred embodiments, many modifications therein will readily occur to those of ordinary skill in the art. Accordingly, all such variations and modifications are included within the intended scope of the invention as defined by the following claims.

What is claimed is:

1. A method comprising:
obtaining data from a device for use as an input to a first cryptographic process;
creating an output of the first cryptographic process wherein the output is valid for a limited period of time; and
writing the output from the first cryptographic process to a storage location after the device is received by a user.

2. The method as set forth in claim 1, wherein the first cryptographic process is based on a time stamp.

3. The method as set forth in claim 1, wherein the data is obtained from the user.

4. The method as set forth in claim 3, wherein the data is entered with at least one of a biometric device, a keypad, and a microphone.

5. The method as set forth in claim 1, further comprising creating an output of a second cryptographic process, wherein the data is used as an input to the second cryptographic process.

6. The method as set forth in claim 5, wherein the second cryptographic process is based on a time stamp.

7. The method as set forth in claim 5, wherein the second cryptographic process is performed by at least one of a device, a point of sale (POS) terminal, a transaction privacy clearing house (TPCH), a vendor, and a financial processing system.

8. The method as set forth in claim 5, further comprising comparing at least one of the output of the first cryptographic process and the input to the first cryptographic process with at least one of the output of the second cryptographic process and the input to the second cryptographic process.

9. The method as set forth in claim 8, further comprising allowing a transaction based on the comparing.

10. The method as set forth in claim 8, further comprising preventing the transaction based on the comparing.

11. The method as set forth in claim 8, wherein the comparing occurs without providing an identity of the user.

12. The method as set forth in claim 1, wherein the device is configured with a limit on transactions to be authorized, the limit being at least one of:
limiting an amount of money to be spent in a given time period;
barring certain users from making certain types of transactions; and barring certain types of transactions.

13. The method as set forth in claim 1, wherein the storage location is selected from the group consisting of a magnetic stripe, a magnetic stripe emulator, a bar code emulator, and a personal transaction card.

14. A computer readable medium containing executable computer program instructions, which when executed by a data processing system, cause the data processing system to perform a method comprising:
obtaining data from a device for use as an input to a first cryptographic process;
creating an output of the first cryptographic process wherein the output is valid for a limited period of time; and
writing the output from the first cryptographic process to a storage location after the device is received by a user.

15. The computer readable medium as set forth in claim 14, wherein the first cryptographic process is based on a time stamp.

16. The computer readable medium as set forth in claim 14, wherein the data is obtained from the user.

17. The computer readable medium as set forth in claim 16, wherein the data is entered with at least one of a biometric device, a keypad, and a microphone.

18. The computer readable medium as set forth in claim 14, the method further comprises creating an output of a second cryptographic process, wherein the data is used as an input to the second cryptographic process.

19. The computer readable medium as set forth in claim 18, wherein the second cryptographic process is based on a time stamp.

20. The computer readable medium as set forth in claim 18, wherein the second cryptographic process is performed by at least one of a device, a point of sale (POS) terminal, transaction privacy clearing house (TPCH), a vendor, and a financial processing system.

21. The computer readable medium as set forth in claim 18, the method further comprises comparing at least one of the output of the first cryptographic process and the input to the first cryptographic process and at least one of the output of the second cryptographic process and the input to the second cryptographic process.

22. The computer readable medium as set forth in claim 21, the method further comprises allowing a transaction based on the comparing.

23. The computer readable medium as set forth in claim 21, the method further comprises preventing a transaction based on the comparing.

24. The computer readable medium as set forth in claim 21, wherein the comparing occurs without providing an identity of the user.

25. The computer readable medium as set forth in claim 14, wherein the device is configured with a limit on transactions to be authorized, the limit being at least one of:
limiting an amount of money to be spent in a given time period;
barring certain users from making certain types of transactions; and
barring certain types of transactions.

26. The computer readable medium as set forth in claim 14, wherein the storage location is selected from the group consisting of a magnetic stripe, a magnetic stripe emulator, a bar code emulator, and a personal transaction card.

27. An apparatus comprising:
security logic used to perform a first cryptographic process wherein an input to the first cryptographic process results in an output of the first cryptographic process wherein the output is valid for a limited period of time; and
a device communicatively coupled with the security logic and configured to write the output of the first cryptographic process to a storage location after the device is received by a user.

28. The apparatus as set forth in claim 27, wherein the storage location is a magnetic stripe emulator.

29. The apparatus as set forth in claim 27, wherein the storage location is a bar code emulator.

30. The apparatus as set forth in claim 27, wherein the storage location is associated with a personal transaction card.

31. The apparatus as set forth in claim 30, wherein the storage location is a magnetic stripe.

32. The apparatus as set forth in claim 27, wherein the first cryptographic process is based on a time stamp.

33. The apparatus as set forth in claim 27, further comprising a user interface communicatively coupled with the security logic, wherein the input to the first cryptographic process comprises data entered from the user interface.

34. The apparatus as set forth in claim 33, wherein the user interface is at least one of a keypad, a biometric unit, and a microphone.

35. The apparatus as set forth in claim 27, wherein the security logic comprises logic that confirms an identification, the identification selected from the group consisting of a personal identification number (PIN) code, voice identification, DNA identification, and biometric data.

36. The apparatus as set forth in claim 27, wherein the device is configured
with a limit on transactions to be authorized, the limit being at least one of:
limiting an amount of money to be spent in a given time period;
barring certain users from making certain types of transactions; and
barring certain types of transactions.

37. An apparatus comprising:
a transaction terminal configured to communicate with a device wherein an output of a first cryptographic process is written from the device to the transaction terminal and the first cryptographic process and a second cryptographic process are used to validate a transaction.

38. The apparatus as set forth in claim 37, wherein the second cryptographic process to be performed by at least one of a transaction terminal, a financial processing system, a transaction privacy clearing house (TPCH), the device, and a vendor.

39. The apparatus as set forth in claim 37, wherein the transaction terminal is selected from the group consisting of a point of sale (POS) terminal, home computer system, bank automatic teller machine (ATM) terminal, digital television, internet appliance, and personal POS terminal.

40. The apparatus as set forth in claim 37, wherein the second cryptographic process is based on a time stamp.

41. The apparatus as set forth in claim 37, wherein a comparison of at least one of the output of the first cryptographic process and the input to the first cryptographic process with at least one of an output of the second cryptographic process and an input to the second cryptographic process allows a transaction if a result of the comparison is within a predetermined range.

42. The apparatus as set forth in claim 41, wherein the comparison occurs at the transaction terminal.

43. The apparatus as set forth in claim 41, wherein the comparison occurs without providing an identity of the user.

44. The apparatus as set forth in claim 37, wherein a comparison of at least one of the output of the first cryptographic process and the input to the first cryptographic process with at least one of an output of the second cryptographic process and an input to the second cryptographic process prevents a transaction.

45. The apparatus as set forth in claim 44, wherein the comparison occurs at the transaction terminal.

46. The apparatus as set forth in claim 44, wherein the comparison occurs without providing an identity of the user.

47. An apparatus comprising:
a transaction terminal configured to communicate with a personal transaction card wherein an output of a first cryptographic process is written from the personal transaction card to the transaction terminal and the first cryptographic process and a second cryptographic process are used to validate a transaction.

48. The apparatus as set forth in claim 37, wherein the second cryptographic process to be performed by at least one of the transaction terminal, a financial processing system, a transaction privacy clearing house (TPCH), a device, and a vendor.

49. The apparatus as set forth in claim 47, wherein the transaction terminal is selected from the group consisting of a point of sale (POS) terminal, home computer system, bank automatic teller machine (ATM) terminal, digital television, internet appliance, and personal POS terminal.

50. The apparatus as set forth in claim 47, wherein the second cryptographic process is based on a time stamp.

51. The apparatus as set forth in claim 47, wherein a comparison of at least one of the output of the first cryptographic process and the input to the first cryptographic process with at least one of an output of the second cryptographic process and an input to the second cryptographic process allows a transaction if the comparison is within a predetermined range.

52. The apparatus as set forth in claim 51, wherein the comparison occurs at the transaction terminal.

53. The apparatus as set forth in claim 51, wherein the comparison occurs without providing an identity of the user.

54. The apparatus as set forth in claim 47, wherein a comparison of at least one of the output of the first cryptographic process and the input to the first cryptographic process with at least one of an output of the second cryptographic process and an input to the second cryptographic process prevents a transaction.

55. The apparatus as set forth in claim 54, wherein the comparison occurs at the transaction terminal.

56. The apparatus as set forth in claim 54, wherein the comparison occurs without providing an identity of the user.

57. The apparatus as set forth in claim 47, wherein the device is configured with a limit on transactions to be authorized, the limit being at least one of:
limiting an amount of money to be spent in a given time period;
barring certain users from making certain types of transactions; and
barring certain types of transactions.
